(19) United States
(12) Patent Application Publication
(10) Pub. No.: US 2020/0380873 A1
(43) Pub. Date: Dec. 3, 2020

(54) METHOD AND SYSTEM FOR PREVENTING COLLISIONS BETWEEN AIRCRAFT AND OTHER FLYING OBJECTS

(71) Applicant: Volocopter GmbH, Bruchsal (DE)

(72) Inventors: Jan-Hendrik BOELENS, Bruchsal (DE); Florian-Michael ADOLF, Frankfurt am Main (DE)

(73) Assignee: Volocopter GmbH, Bruchsal (DE)

(21) Appl. No.: 16/883,319

(22) Filed: May 26, 2020

(30) Foreign Application Priority Data
May 28, 2019 (DE) 102019114354.3

(51) Int. Cl. G08G 5/00

(52) U.S. Cl. CPC G08G 5/0013; G08G 5/04; G08G 5/0082; G08G 5/0021

(57) ABSTRACT

A method and a corresponding system for preventing collisions between registered aircraft (6.1, 6.2, 6.3) and of registered aircraft with unregistered aircraft and with other objects, in particular flying objects (6.4) in an airspace (2). The airspace is continuously captured by at least one ground station (3.1, 3.2, 3.3) by a number of sensors (4.1-4.8) in order to obtain appropriate airspace data. The airspace data are automatically evaluated by a ground computer (7.1-7.3) in the ground station or in a higher-level monitoring station to which the at least one ground station transmits its airspace data, in order to provide flight data, in particular a current position and a predicted movement or flight path of the aircraft and objects. The flight data are provided by the ground computer at least for the registered aircraft. At least the registered aircraft use the flight data for their real-time flight path planning.

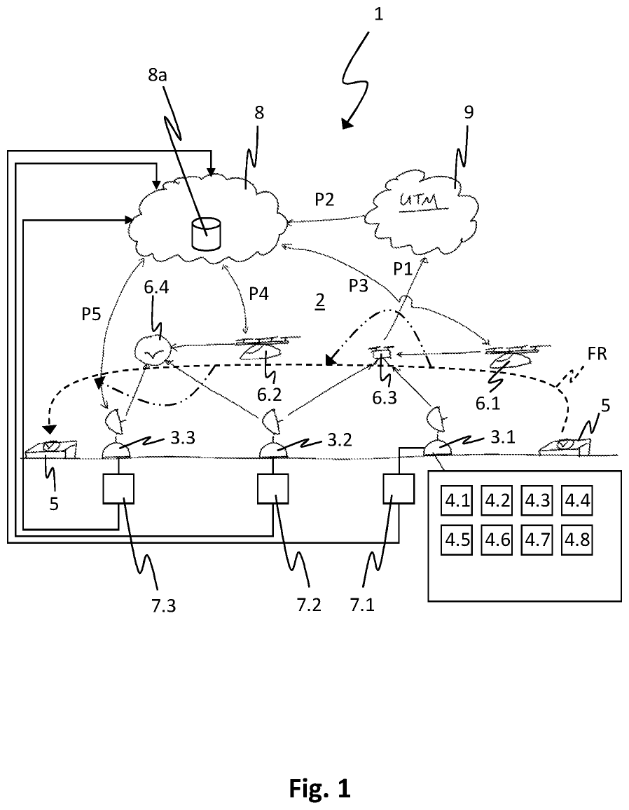

### INCORPORATION BY REFERENCE

The following documents are incorporated herein by reference as if fully set forth: German Patent Application No. DE 10 2019 114 354.3, filed May 28, 2019.

### TECHNICAL FIELD

The invention concerns a method for preventing collisions between registered aircraft and of registered aircraft with unregistered aircraft and with other objects, in particular flying objects in an airspace.

Further, the invention concerns a distributed monitoring system for the avoidance of collisions between registered aircraft and of registered aircraft with unregistered aircraft and with other objects, in particular flying objects in an airspace.

### BACKGROUND

An airspace control system for at least one unmanned aircraft is known from US 2019/019418 A1. For this purpose, unmanned aircraft will be equipped with an additional box containing sensors, a receiving and transmitting unit and a computer, whereby the aircraft can perceive its surroundings by sensor and can exchange the (sensor) data obtained in this way with other unmanned aircraft and a virtual air traffic control system.

Such a system therefore requires that aircraft, in particular passenger-carrying aircraft, are extensively equipped with sensors to enable 360° coverage of the airspace around the aircraft. For safety reasons, it is also necessary to use multiple different types of sensors to be able to perform plausibility checks of the determined data. This also requires the implementation of a powerful computer in the aircraft in order to be able to analyze the determined sensor data and translate it into usable data. Such systems therefore represent a not insignificant weight increase and a larger energy consumption in addition to high costs and increasing system complexity, which in turn can adversely affect the weight, payload and/or range (especially in the case of electrically powered aircraft).

This disadvantage is further increased by the fact that for safety or redundancy reasons even multiple sensors and computers have to be carried on board, which requires a corresponding redundant power supply. In addition, the built-in on-board sensors (for example lidar) cause increased power consumption as well as a negative impairment of the aerodynamic design of the structure of the aircraft or flying machine.

The terms “aircraft” and “flying machine” shall be used synonymously below, unless otherwise stated. These are not limited to manned or unmanned aircraft, but include all types of “artificial” aircraft, for example multicopters, in particular of the Volocopter® type multicopter from the applicant's operation, or drones, but also hot air balloons or paragliders. On the other hand, the term “flying object” refers to all other types of flying objects or elements, for example birds or flocks of birds.

In addition, it is to be considered to be disadvantageous that the range and resolution of on-board sensors are limited due to the stated limitations of weight, power consumption and installation space. Acoustic sensors, which could be used for drone detection due to the characteristic noise emission, are not practical as on-board sensors due to characteristic noise and airflow.

The evaluation of (sensor/measurement) data obtained in this way poses a particular challenge, especially in urban environments, as the data regularly contain a lot of noise or interference, so that the actual risk of collision can only be determined with a lot of effort. This applies both to the actual detection of obstacles (for example birds or other aircraft) and their subsequent flight path assessment.

For this reason, a large number of different real-time data are necessary for safe collision avoidance, which is difficult to provide in sufficient quality on board the aircraft. Furthermore, it is difficult to process such data with the necessary accuracy and integrity in real time when, as shown, the available installation space or energy supply, and thus the available resources, are limited.

### SUMMARY

The invention is based on the object of remedying this situation and specifying a method or system with which the risk of collision for aircraft can be significantly reduced without compromising on data processing (i.e. safety) and without adversely affecting the aircraft in terms of cost, weight, power consumption and aerodynamics.

The object is achieved according to the invention by a method as well as by a distributed monitoring system with one or more of the features described herein.

Advantageous developments of the idea according to the invention are the provided below and in the claims.

A method according to the invention for the avoidance of collisions between registered aircraft as well as of registered aircraft with unregistered aircraft and with other objects, in particular flying objects in an airspace provides that a) the airspace is continuously sensed by at least one ground station by a number of sensors in order to obtain corresponding airspace data; that b) the airspace data are automatically evaluated by a ground computer in the ground station or in a higher-level monitoring station to which at least one ground station transmits its airspace data, in order to obtain flight data, in particular a current position and a predicted movement or flight path, of the aircraft and the objects; that c) the flight data are provided by the ground computer at least for the registered aircraft; and d) at least the registered aircraft use the flight data for their real-time flight path planning.

A distributed monitoring system according to the invention for the avoidance of collisions between registered aircraft as well as of registered aircraft with unregistered aircraft and with other objects, in particular flying objects in an airspace, comprises: a) at least one ground station with a number of sensors, which is designed for continuous sensing of the airspace in order to obtain corresponding airspace data; b) at least one ground computer which is designed for the automated evaluation of the airspace data and which is located in or is connected to a higher-level monitoring station in order to obtain the airspace data from the at least one ground station and to obtain flight data, in particular a current position and a predicted movement or flight path, at least of the unregistered aircraft and the objects; and c) a communication network to which the ground computer is connected in order to provide the flight data at least for the registered aircraft in the communication network.

In the context of this description, a “registered aircraft” means an aircraft whose type, flight plan and flight routes and other characteristics where applicable are known to the regularly present (official) airspace control facilities, in particular by means of appropriate notification prior to take-off. An “unregistered aircraft” is therefore an aircraft that is unknown to the airspace control facilities, for example a model aircraft or a drone. Only the registered aircraft can be influenced according to the method according to the invention and integrated into the system according to the invention.

In the following, a “ground station” is not intended to mean exclusively a station on the ground. Rather, “ground stations” are also to be understood as sensor systems arranged by or on buildings or masts. Furthermore, not only static stations should be understood by the term “ground station”, but these can also be mobile, for example as vehicles moving on the ground, or drones in the air, which preferably perform locally limited movements or move/stay only within a locally limited range.

In the context of the present invention, not only flying objects are recognized. Extensive 3D maps of a route to be flown, of buildings for example, will be available. By means of the method described here, however, for example cranes that have been newly installed can be detected and their position data (and/or movements, such as swiveling movements of an operated crane) can be transmitted to the aircraft.

In order to make the aircraft or aircraft in question as light and simple as possible, according to the invention on-board, preferably only flight-relevant sensors are available, i.e. sensors without which the aircraft would not be airworthy at all, for example an inertial measuring unit or a satellite navigation system. The airspace to be flown is monitored by the at least one ground station, but preferably by distributed, in particular static and/or ground-based, sensor systems, which transmit their data to a ground-based computer (the ground computer), preferably with a connected database. The aircraft are preferably in constant data contact with the ground computer or the database and receive from it all data (the flight data) relevant to the respective flight path (flight path planning). These data preferably contain all information available in the ground computer or in the database regarding the registered and unregistered airspace participants, thus preferably providing a complete representation of the entire airspace in a given area.

For example, the flight path planning for the registered aircraft can take place on board, i.e. by means of an on-board computer located on board the respective aircraft. Accordingly, in a preferred development of the method according to the invention, it is provided that the flight path planning for the aircraft is carried out on board by means of an on-board computer located on board the respective aircraft.

However, it is also possible that the flight path planning is carried out on a central or distributed ground computer(s), which transmits the calculated flight routes to the respective aircraft by means of data transmission.

In a preferred development of the method according to the invention, it is provided that the ground computer sends the flight data at least partially directly to the registered aircraft. There the data can then be used decentrally for the (real-time) flight planning of the aircraft, for example to avoid a detected obstacle (for example an unregistered aircraft along its own flight path), preferably automatically.

In another preferred development of the method according to the invention, it is provided that the ground computer sends at least part of the flight data to a database, from which database the flight data are retrieved by the registered aircraft. This database, which can be designed as a cloud database or a “situational awareness cloud”, then preferably has all relevant flight data in the airspace, and all airspace participants can inform themselves accordingly.

In a corresponding preferred development of the system according to the invention, it is provided that this further comprises a database, which is communicatively connected to the ground computer in order to receive therefrom at least a part of the flight data, which database is developed to communicate with the registered aircraft and to provide the flight data for the registered aircraft for retrieval.

Mixed systems are also possible, for example with retrieval of data by the aircraft from the database in the “normal case” and active sending of data from the ground computer or from the database to the registered aircraft in an “emergency”, for example in a case of an acutely high probability of a collision.

In a development method of the according to the invention that is preferred in this context, it is provided that after detection of an unregistered aircraft or another obstacle, for example a flying object, whose position and/or whose flight path is/are determined by the ground computer to come in range of a registered aircraft or its planned flight path, the corresponding data are transmitted to the affected registered aircraft from the ground-computer or the database. The registered aircraft can take the data into account in its flight path planning and can evade the obstacle or can fly past it.

In a preferred development of the method according to the invention, it is provided that the registered aircraft are in constant data contact with the ground computer or the database and receive therefrom all relevant data for their respective flight path planning. In this way, each registered aircraft in the airspace is constantly informed of all other flying objects, their position and flight path and can take this into account in flight planning.

In another preferred development of the method according to the invention, it is provided that multiple ground stations are used, which cover the airspace completely by sensing, wherein airspace areas of the individual ground stations covered by sensing preferably overlap at least partially. In this way, there can be no gaps in the airspace coverage, which increases safety.

A corresponding development of the system according to the invention provides that there are multiple ground stations, which cover the airspace completely by sensing, wherein preferably airspace areas of the individual ground stations that are covered by sensing overlap at least partially.

In particular, if the flight routes are essentially fixed and pre-known, for example in the case of the future planned air taxis, a development of the system according to the invention is advantageous, with which there are multiple ground stations distributed along a previously known flight path in order to capture or cover these for sensing as well as possible.

In a corresponding development of the method according to the invention it is provided that multiple ground stations distributed along a pre-known flight distance are used. As a result, even larger areas (airspace) can be completely covered.

In a preferred development of the method according to the invention, it is provided that multiple different sensor systems are used in the ground station or the ground stations for capturing the airspace, in particular radar, lidar, electro-optical sensors and acoustic sensors, FLARM, ADSB and similar sensors. FLARM is a collision warning device used in light aircraft. It essentially comprises a GPS receiver and a digital radio module consisting of a transmitter, which transmits inter alia the current position of the device in the vicinity (a few kilometers) to other FLARMs, and an associated receiver. The data transfer is carried out at a configurable frequency (in Europe 868.2 and 868.4 MHz). ADSB, Automatic Dependent Surveillance—Broadcast, is an air traffic control system for displaying flight movements in airspace. The aircraft determine their positions independently, for example via satellite navigation systems, such as GPS. The position and other flight data, such as flight number, aircraft type, time stamp, speed, altitude, and planned flight direction, are emitted non-directionally and continuously, typically once per second. These sensor systems can complement each other, which increases resilience. In addition, different sensor systems respond differently to certain physical conditions, so that the detection rate can be increased when different measurement methods are used. Acoustic sensor systems in particular have proven their worth in drone detection. Furthermore, by comparing the data collected by different sensors, confidence can be increased in these data and the evaluation thereof, such as a predicted motion or flight path of an object.

Thus, a corresponding development of the system according to the invention provides that position data of the aircraft captured by the ground stations are in turn transmitted to the aircraft themselves, whereby validation of the GPS position determined on board and thus a higher confidence of the position determination can be achieved.

A corresponding development of the system according to the invention provides that there are multiple different sensor systems for capturing the airspace in the ground station or in the ground stations, in particular radar, lidar, electro-optical sensors and acoustic sensors, FLARM, ADSB and similar sensors.

In an exceedingly preferred development of the method according to the invention, it is provided that the registered aircraft have their own sensor systems and transmit their own sensor data at least partially to the ground station or to the database and/or compare the specifically determined sensor data with those of the ground stations. In this way too, confidence in the specifically determined data can be increased. This will improve the outcome of the airspace capture. The on-board sensors, such as cameras, radar, etc., can also act as a “last fallback unit” in the event of a failure of the distributed ground-based sensor systems or in the event of a failure of the data communication to the aircraft, which further increases safety.

A corresponding development of the system according to the invention provides that the registered aircraft have their own sensor systems, which are part of the distributed monitoring system and which are designed to transmit their own sensor data at least partially to the ground station or to the database.

In another preferred development of the method according to the invention, it is provided that the data transmission to the registered aircraft takes place by means of a cellular connection, for example according to the 3G, 4G or 5G standard, preferably essentially in real time, i.e. with low latency, to enable fast reactions. For 5G networks, the latency can drop to values around 1 ms.

A corresponding development of the system according to the invention provides that the communication network for the data transmission to the registered aircraft is or uses a cellular network, preferably with real-time capability or low latency. Preferably, the latency can be at 100 ms or below. A (flying) object moving at 200 km/h travels a distance of about 5 meters during this time, which is a good value for real-time collision avoidance.

With a preferred development of the method according to the invention, it is provided that said data include a position, a location and/or a calculated flight path of the (un/)registered aircraft, flying object or obstacle, or data for a newly calculated flight path, in particular including waiting and/or evasive maneuvers, are transmitted to the affected registered aircraft. In the former case, the aircraft or its pilot himself takes over the further flight path planning based on the data; in the second case, it only needs to follow the pre-planned (alternative) route.

In a preferred development of the method according to the invention, it is provided that only tracking data of detected, unregistered aircraft or flying objects are transmitted to the registered aircraft, in particular their position, size, probable flight path or the like, for example type or model designation, category of aircraft, and category of flying object. This essentially corresponds to the first case mentioned above. The aircraft or its on-board computer uses the tracking data of the detected aircraft/flying objects to adjust its flight path planning if necessary.

With another preferred development of the method according to the invention, it is provided that additionally an airspace management system, for example a UTM—unmanned traffic management system or an ATM—air traffic management system, is provided, in which the aircraft participating in aviation preferably register before take-off. If the method according to the invention is combined with inherently known airspace management systems in this way, the achievable safety increases once again. In addition, there are synergy effects, because well-known UTM/ATM systems already provide for the management of or communication with aircraft, which can be at least partially made use of.

A corresponding development of the system according to the invention provides that there is additionally an airspace management system, for example a UTM—unmanned traffic management system or an ATM—air traffic management system, in which the aircraft participating in aviation preferably register before take-off, wherein the database is preferably part of the airspace management system.

In another preferred development of the method according to the invention, it is accordingly provided that registered aircraft transmit their planned flight routes to the ground computer or to the database, with which database the registered aircraft are in constant data contact, wherein the database may be part of the aforementioned airspace management system.

Some particularly interesting special embodiments of the invention are additionally discussed below:

The ground stations can be advantageously equipped with multiple sensors or sensor types, in particular radar, electro-optical sensors and acoustic sensors, but also FLARM, ADSB or the like, as has already been pointed out. Connecting multiple ground stations in a cloud or a so-called cloud platform makes it possible to create a situational image of the entire airspace, which can then be transmitted to the registered aircraft in an appropriate form. The registered aircraft, for their part, also feed their sensor data into a cloud formed from a ground computer and, if necessary, the database, if the method is appropriately designed.

More powerful sensors can be used in ground stations than on board an aircraft, as the limitations in terms of space, weight and energy consumption are not so severe. In this way, a more complete situational picture of the airspace can be provided without the need to install expensive, heavy sensors on board the aircraft.

A warning of a possible collision can be made earlier compared to purely on-board systems, since the sensors preferably distributed in the ground stations allow a wider “forward look” and “all-round view”. As a result, the flight path planning for the individual aircraft can be adapted in good time.

Acoustic sensors can also be used, which is hardly possible on board because of the noise emission of the rotors. These can detect drones based on a characteristic noise, for example.

In the case of the Volocopter®, inner-city point-to-point connections are planned, i.e. the airspace to be flown is known, at least for the most part, which is highly appropriate to an installation of the system according to the invention. For the monitoring of this airspace, distributed sensor systems, in particular static and/or ground-based sensor systems can be used, as proposed. When “sensor systems” are mentioned here and elsewhere, this means a plurality of sensors with the corresponding control, connection, communication, and supply electronics. The terms “sensor” and “sensor system” can be used as synonyms since the aforementioned electronics do not matter here. The sometimes complex evaluation of the data supplied by these sensor systems can be carried out by a computer within the sensor systems themselves. However, it is also possible that the data are forwarded to at least one cloud separate from the sensors or sensor systems or to a data center for processing and evaluation, and from there to the aircraft (such a cloud can be referred to as a “situational awareness cloud”, as has already been pointed out; basically, cloud or cloud computing stands for an IT infrastructure, which is made available locally, for example via the Internet or another communication network over more or less long distances. It usually includes storage space, computing power and/or application software as a service). The results can be transmitted to a (cloud) database with which the registered aircraft in the airspace are in constant data contact. On the basis of this data, a human pilot or an auto-pilot of an aircraft concerned may adjust the planned flight route in real time if necessary.

Thus, the (hardware and software) complexity in detecting obstacles is shifted from the aircraft to the distributed static sensor systems, resulting in enormous weight savings (and lower system complexity) in the aircraft.

The distributed static sensor systems can perceive in particular unregistered participants in aviation traffic, such as drones and/or birds, and their location, but can also determine a probable flight path and preferably transmit this to the cloud database. At the same time, the registered aircraft are preferably in data contact with the cloud database at all times. Once an obstacle has been identified, the location or calculated flight path of which comes within range of a registered aircraft or its planned flight path, the aircraft concerned may receive the relevant data from the cloud database.

As the person skilled in the art will recognize, in principle the concept underlying the invention is not limited to cloud applications and the use of corresponding databases.

The aforementioned data may include, for example, the location and/or the calculated flight path of the obstacle (flying object or unregistered participant in air traffic), or directly a recalculated flight path (or a waiting or evasive maneuver) so that a collision with the detected object can be prevented, as has already been pointed out. However, it is preferred that aircraft are only provided with the “tracking data” of the detected, unregistered participants in aviation traffic, i.e. in particular their position, size, probable flight path, etc. The decision as to whether the planned flight path for an affected registered aircraft is adapted because of this is preferably still taken by the aircraft itself (on board), i.e. by its pilot or auto-pilot.

Since the sensor systems can only cover a certain area or a certain volume of the airspace to be flown, static sensor systems are preferably arranged along an entire flight path. The distance between these sensor systems should be chosen at least so that there are no areas or volumes of the airspace that cannot be monitored. Preferably, however, the areas or volumes monitored by the sensor systems overlap, so that there are at least a number of areas or volumes that are monitored by at least two sensor systems simultaneously. This allows obstacles and their locations and/or flight paths to be determined even more precisely. With regard to safety requirements, a particularly redundant and thus safe monitoring of the area or volume to be flown can also be ensured.

It has already been noted that in the context of developments of the invention this can interact with an airspace management system (UTM (unmanned traffic management) or ATM (air traffic management), wherein the airspace management system is usually provided officially, for example by authorities, state, etc. With the airspace management system, aircraft participating in air traffic register before take-off. This ensures that the planned flight routes of the large number of aircraft do not collide. The air traffic participants registered in the airspace management system and their planned routes may be transmitted to the cloud database with which the aircraft can be in constant data contact, as mentioned above. In this context, it is also possible that the data in the “situational awareness cloud” is (co)managed by the UTM/ATM. It is even possible that the “situational awareness cloud” is integrated into the UTM/ATM.

Furthermore, it should be noted that in the context of the invention an inspection of the data processing process (for example by a sample) by trained personnel on the ground is much easier than by a pilot on board (also in terms of workload) or as a transmission to a ground station for checking.

### BRIEF DESCRIPTION OF THE DRAWINGS

Further properties and advantages of the invention arise from the following description of exemplary embodiments based on the drawing.

The sole FIGURE shows schematically a system for airspace monitoring consisting of distributed static sensor systems, a cloud database, an airspace management system, and aircraft (flying machines) flying in the airspace and other aircraft.

### DETAILED DESCRIPTION

In the FIGURE, a distributed monitoring system according to the invention for the avoidance of collisions between registered aircraft and of registered aircraft with unregistered aircraft and with other objects, in particular flying objects in an airspace, is shown. The system is referred to in total with the reference character 1, the airspace with the reference character 2. Reference characters 3.1, 3.2 and 3.3 denote ground stations, each with a number of different sensors or sensor systems, which is explicitly shown in the FIGURE for only one of the ground stations 3.1. The sensors or sensor systems are denoted in the FIGURE by reference characters 4.1 through 4.8 and may, without limitation, include electro-optical sensors, infrared sensors, acoustic sensors, radar (sensors), laser-assisted sensors and lidar sensors. The invention is however not limited to a certain number or combination of sensor systems. FLARM or ADSB can also be used.

The ground stations 3.1-3.3 are arranged along a fixed flight route FR, which connects take-off and landing stations 5 specifically for passenger-carrying aircraft, for example of the Volocopter® type multicopters, which aircraft are designated in the FIGURE with reference characters 6.1 and 6.2 respectively. However, the invention is not limited to such an arrangement of ground stations 3.1-3.3 and to such designs of the aircraft 6.1, 6.2.

In the embodiment shown, each of the ground stations 3.1-3.3 works together with a ground computer 7.1-7.3 or comprises such a ground computer 7.1-7.3, which ground computer 7.1-7.3 is designed for automated evaluation of airspace data supplied by the ground stations 3.1-3.3 or the sensor systems 4.1-4.8 available there. The sensor systems 4.1-4.8 present in ground stations 3.1-3.3 are determined and designed to continuously capture the airspace 2 at least in an area or volume of the airspace 2 assigned to the respective ground stations 3.1-3.3 in order to obtain corresponding airspace data, which are then further processed in said ground computers 7.1-7.3.

As the person skilled in the art will recognize, the invention is also in no way limited to all ground stations 3.1-3.3 being of identical design and having to have the same sensor systems 4.1-4.8, although this may be preferred.

The ground computers 7.1-7.3 may also be arranged directly within the ground stations 3.1-3.3, which is not explicitly shown in the FIGURE. Instead of multiple ground computers 7.1-7.3, there may be a single, higher-level ground computer, which works with all or some of the ground stations 3.1-3.3 for data-technology purposes. This is not shown in the FIGURE. Such a higher-level ground computer may be provided in a higher-level monitoring station to which all or at least some of the ground stations 3.1-3.3 are connected (wirelessly or by wire) for data technology purposes.

The ground computers 7.1-7.3 obtain the airspace data from the respective ground station 3.1-3.3 and determine (calculate) so-called flight data therefrom, in particular a current position or location and a predicted movement of the flight path of aircraft and objects in the airspace 2.

On the one hand, these aircraft and objects may be the aircraft 6.1, 6.2 mentioned above. These are so-called registered aircraft, which will be discussed in more detail below. The aircraft and flying objects mentioned above also include other aircraft in the form of drones or the like 6.3, wherein in the present exemplary embodiment this is also a registered aircraft (see below). On the other hand, reference character 6.4 represents an unregistered flying object in the form of a bird or a flock of birds. As symbolized by arrows outgoing from the base stations 3.1-3.3 in the FIGURE, ground stations 3.1-3.3 use sensor-based measurements to determine airspace data, such as size, distance, direction of movement, speed, etc., at least of certain aircraft 6.3 and flying objects 6.4, and send these airspace data to the ground computers 7.1-7.3, which determine the aforementioned flight data.

The ground computers 7.1-7.3 are in turn connected to a communication network in order to provide the flight data at least for the registered aircraft 6.1, 6.2 in the communication network. According to the FIGURE, this communication network comprises a cloud 8, which in the present case is also referred to as a “situational awareness cloud” and in particular comprises a database 8a, which is symbolically indicated in the FIGURE. The communication network may be implemented as a cellular network according to the 3G, 4G or 5G standard, but is not limited to this. In addition to the cloud 8, an (official) airspace management system is also provided, here a UTM system 9 (unmanned traffic management) as an example and without restriction.

All registered airspace participants, i.e. aircraft 6.1-6.3 according to the FIGURE, are communicatively connected to the cloud 8 and the UTM 9 in the communication network. This is indicated in the FIGURE for the drone 6.3, which transmits data regarding its flight planning to the UTM 9 according to the arrow P1. From there, the corresponding information is transferred to the cloud 8 according to the arrow P2 and is available there, as well as the flight data determined by the ground computers 7.1-7.3, as described above.

In addition to the ground stations 3.1 and 3.2, on-board sensors of the aircraft 6.1 also capture the drone 6.3, and the aircraft 6.1 sends corresponding data to the cloud 8, from which it also receives data regarding the drone 6.3, which is symbolized in the FIGURE by the double arrow P3. The latter data come from the UTM 9 on the one hand, where the drone 6.3 is registered, and from the ground stations 3.1 and 3.2, which captured the drone 6.3 as described above.

The bird or flock of birds at reference character 6.4 will be captured by both the on-board sensors of the aircraft 6.2 and the ground stations 3.2, 3.3. The aircraft 6.2 sends corresponding information to the cloud 8 and obtains from there information provided by ground stations 3.2, 3.3, as symbolized by the double arrow P4. Reference character P5 stands for the bidirectional communication between (as an example) the ground station 3.3 and the cloud 8 regarding airspace data of the bird or flock of birds 6.4. The data transmission is bidirectional, because on the one hand the ground station 3.3 provides its measurement data or its evaluation in the cloud 8 and on the other hand also obtains from there further data or information about the object 6.4, which was provided for example by other ground stations 3.2 or aircraft 6.2. This can increase the capture and evaluation accuracy.

The aircraft 6.1, 6.2 may use the information obtained from the cloud 8 to change their flight path in the course of real-time flight path planning (in particular automatically) carried out on board and to avoid obstacles (in particular automatically) on the flight route FR. This is shown in the FIGURE by means of dotted arrows. For this purpose, at least the aircraft 6.1 and 6.2 have a correspondingly designed on-board computer, which is not further represented in the FIGURE.

The totality of the individual systems (ground stations, computers, sensor systems, aircraft, etc.) and the respective relationships between the systems is only shown in the FIGURE as an example, wherein the connections and relationships shown are merely exemplary and not a conclusive representation. In particular, of course, a communication or data-technology connection between the individual registered traffic participants (Volocopter®) and with a UTM system is also possible.

1. A method for preventing collisions between registered (6.1, 6.2, 6.3) aircraft and of registered (6.1, 6.2, 6.3) aircraft with unregistered aircraft and other objects (6.4) in an airspace (2), the method comprising:
a) continuously capturing a state of the airspace (2) by at least one ground station (3.1, 3.2, 3.3) using a number of sensors (4.1-4.8) in order to obtain airspace data;
b) automatically evaluating the airspace data using a ground computer (7.1-7.3) in the at least one ground station (3.1, 3.2, 3.3) or in a higher-level monitoring station to which the at least one ground station (3.1, 3.2, 3.3) transmits said airspace data, in order to obtain flight data of the aircraft (6.1, 6.2, 6.3) and of the objects;
c) providing the flight data from the ground computer (7.1-7.3) to at least for the registered aircraft (6.1, 6.2, 6.3); and
d) at least the registered aircraft (6.1, 6.2, 6.3) using the flight data for real-time flight path planning.

2. The method as claimed in claim 1, wherein the ground computer (7.1-7.3) sends the flight data at least in part directly to the registered aircraft (6.1, 6.2, 6.3) on the ground.

3. The method as claimed in claim 1, wherein the ground computer (7.1-7.3) sends the flight data at least in part to a database (8a), and the registered aircraft (6.1, 6.2, 6.3) retrieve the flight data from the database (8a).

4. The method as claimed in any claim 3, wherein the registered aircraft (6.1, 6.2, 6.3) are in constant data contact with the ground computer (7.1-7.3) or the database (8a) and receive all data relevant for respective flight path planning therefrom.

5. The method as claimed in claim 1, wherein the flight path planning for the aircraft (6.1, 6.2, 6.3) is carried out on board by an on-board computer located on board the respective aircraft (6.1, 6.2, 6.3).

6. The method as claimed in claim 1, wherein the flight path planning for the aircraft (6.1, 6.2, 6. 3) is carried out by a central ground station or multiple distributed ground stations (3.1, 3.2, 3.3) and the planned flight paths are transmitted to the aircraft (6.1, 6.2, 6.3) using data transmission.

7. The method as claimed in claim 1, wherein multiple ones of the ground stations (3.1, 3.2, 3.3) are used which cover the airspace (2) completely for sensing, and airspace areas of the individual ground stations (3.1, 3.2, 3.3) that are covered for sensing overlap at least partially.

8. The method as claimed in claim 1, wherein multiple different sensor systems (4.1-4.8) are used in the ground station (3.1, 3.2, 3.3) or the ground stations (3.1, 3.2, 3.3) for capturing the state of the airspace (2), including at least one of: radar, lidar, electro-optical sensors and acoustic sensors, FLARM, or ARSB.

9. The method as claimed in claim 3, wherein the registered aircraft (6.1, 6.2) include onboard sensor systems and transmit sensor data from the onboard sensor systems at least partially to the ground station (3.1, 3.2, 3.3) or to the database (8a).

10. The method as claimed in claim 3, wherein after detection of an unregistered aircraft or any other obstacle (6.4), a position or flight path of which as determined by the ground computer (7.1-7.3) comes within range of one of the registered aircraft (6.1, 6.2, 6.3) or the planned flight path thereof, the method further comprising the transmitting corresponding data from the ground computer (7.1-7.3) or the database (8a) to the relevant registered aircraft (6.1, 6.2, 6.3).

11. The method as claimed in claim 10, wherein the data transmission to the registered aircraft (6.1, 6.2, 6.3) is carried out by a cellular connection.

12. The method as claimed in claim 10, wherein the corresponding data includes a position, and at least one of a location or a calculated flight path of the unregistered aircraft or obstacle (6.4), or data for a recalculated flight path, including at least one of waiting or evasive maneuvers, and the method further comprises transmitting the corresponding data the affected one of the registered aircraft (6.1, 6.2, 6.3).

13. The method as claimed in claim 1, further comprising transmitting tracking data of detected, unregistered aircraft or flying objects (6.4) to the registered aircraft (6.1, 6.2, 6.3).

14. The method as claimed in claim 1, further comprising using multiple ones of the ground stations (3.1, 3.2, 3.3) distributed along a known air route or flight route (FR).

15. The method as claimed in claim 1, further comprising providing an airspace management system with which the aircraft participating in aviation traffic (6.1, 6.2, 6.3) register before take-off.

16. The method as claimed in claim 15, wherein the registered aircraft (6.1, 6.2, 6.3) transmit planned flight routes (FR) to the ground computer (7.1-7.3) or to a database (8a), and the registered aircraft (6.1, 6.2) are in constant data contact with the database (8a), wherein the database (8a) is part of the airspace management system (9).

17. A distributed monitoring system (1) for preventing collisions between registered aircraft (6.1, 6.2, 6.3) and of registered aircraft (6.1, 6.2, 6.3) with unregistered aircraft and with other objects in an airspace (2), the system comprising:
a) at least one ground station (3.1, 3.2, 3.3) with a number of sensors (4.1-4.8) configured for continuous sensing capture of a state of the airspace (2) to obtain airspace data;
b) at least one ground computer (7.1-7.3) configured for automated evaluation of the airspace data and which is used in the at least one ground station (3.1, 3.2, 3.3) or in a higher-level monitoring station or is connected thereto in order to obtain the airspace data from at least one ground station (3.1, 3.2, 3.3) and is further configured to determine therefrom flight data of the unregistered aircraft and the objects (6.4), including a current position and a predicted movement or flight path; and
(c) a communication network to which the ground computer (7.1-7.3) is connected that is configured to provide the flight data at least for the registered aircraft (6.1, 6.2, 6.3) in the communication network.

18. The distributed monitoring system (1) as claimed in claim 17, further comprising a database (8a) which is communicatively connected to the ground computer (7.1-7.3) in order to receive therefrom at least part of the flight data, said database (8a) is further configured to communicate with the registered aircraft (6.1, 6.2, 6.3) and to provide the flight data for the registered aircraft (6.1, 6.2, 6.3) for retrieval in the communication network.

19. The distributed monitoring system (1) as claimed in claim 18, wherein there are multiple ones of the ground stations (3.1, 3.2, 3.3) which cover the airspace (2) completely for sensing, and airspace areas of individual ones of the ground stations (3.1, 3.2, 3.3) that are covered for sensing overlap at least partially.

20. The distributed monitoring system (1) as claimed in claim 17, wherein there are multiple different sensor systems (4.1-4.8) for capturing the state of the airspace (2) in the ground station (3.1, 3.2, 3.3) or in the ground stations (3.1, 3.2, 3.3), including at least one of radar, lidar, electro-optical sensors and acoustic sensors, FLARM, or ARSB.

21. The distributed monitoring system (1) as claimed in claim 18, further comprising onboard sensor systems in the registered aircraft (6.1, 6.2, 6.3) which are part of the distributed monitoring system (1) and which are configured to transmit onboard sensor data at least partially to the ground station (3.1, 3.2, 3.3) or to the database (8a).

22. The distributed monitoring system (1) as claimed in claim 17, wherein the communication network for data transmission to the registered aircraft (6.1, 6.2, 6.3) is or uses a cellular network.

23. The distributed monitoring system (1) as claimed in claim 17, wherein there are multiple ones of the ground stations (3.1, 3.2, 3.3) distributed along a known flight path.

24. The distributed monitoring system (1) according to claim 18, further comprising an airspace management system in which the aircraft participating in aviation traffic (6.1-6.3) register before take-off, and the database (8a) is part of the airspace management system.
